(19) United States
(12) Patent Application Publication
(10) Pub. No.: US 2015/0275042 A1
(43) Pub. Date: Oct. 1, 2015

(54) CURING RESIN COMPOSITION AND USES THEREOF

(71) Applicant: CHI MEI CORPORATION, TAINAN CITY (TW)

(72) Inventor: YU-JIE TSAI, TAINAN CITY (TW)

(21) Appl. No.: 14/662,794

(22) Filed: Mar. 19, 2015

(30) Foreign Application Priority Data
Mar. 28, 2014 (TW) 103111600

(51) Int. Cl. C09D 183/04; C08K 5/3492

(52) U.S. Cl. CPC C09D 183/04; C08K 5/3492

(57) ABSTRACT

The invention relates to a curing resin composition, a thin film and a liquid crystal display element formed by the composition. The curing resin composition has the advantage of good adhesion and coating property. The curing resin composition comprises a polysiloxane (A), a triazine-based compound (B), and a solvent (C).

### BACKGROUND OF THE INVENTION

1. Field of the Invention

The invention relates to a curing resin composition, a thin film and a liquid crystal display element formed by the composition. More particularly, the invention provides a curing resin composition having good adhesion and coating properties.

2. Description of the Related Art

In the field of manufacturing a liquid crystal display element, forming a thin film on a substrate is an important technique. When manufacturing an optical element, for example, a liquid crystal display element or a solid-state imaging device, the processing procedure needed to be carried on in a harsh condition, such as immersing a surface of a substrate in an acid solution or alkali solution, or generating local high temperature when forming a wiring electrode layer by sputtering. Therefore, it is needed for the element to apply a protective film on its surface for avoiding damaging when manufacturing. Nowadays, the protective film is usually formed on the substrate by a heat curing resin composition via the processes such as coating, pre-baking, and after-baking.

For the protective film with the aforementioned properties, besides high transparency, surface hardness and smoothness, the protective film also requires good adhesion with the substrate; more importantly, the thin film requires good water resistance, solvent resistance, acid resistance, and alkali resistance.

Japanese Patent Publication No. 05-78453 discloses a conventional heat curing resin composition. It uses a polymer having a glycidyl group. However, the protective film formed by the conventional heat curing resin composition has a defect of poor adhesion and coating properties.

Therefore, a curing resin composition that enhances the adhesion and coating property at the same time is a target remained to be achieved.

### SUMMARY OF THE INVENTION

In the present invention, a specific polysiloxane, a heat acid generating agent and a triazine-based compound are provided to obtain a curing resin composition having good adhesion and coating properties.

Therefore, the present invention provides a curing resin composition comprising:
a polysiloxane (A);
a triazine-based compound (B); and
a solvent (C);
wherein:
the polysiloxane (A) comprises a polysiloxane (A-1) having an acid anhydride group or epoxy group, and the polysiloxane (A-1) is obtained by subjecting a reactant to hydrolysis and partial condensation, and the reactant includes at least one silane monomer having a structure of Formula (1):

Si(R¹)ₜ(OR²)₄₋ₜ Formula (1),
t represents an integer from 1 to 3; when t represents 2 or 3, a plurality of R¹ are independently the same or different; and when 4−t represents 2 or 3, a plurality of R² are independently the same or different;
at least one of R¹ represents a C₁-C₁₀ alkyl group substituted by an acid anhydride group, a C₁-C₁₀ alkyl group substituted by an epoxy group or an alkoxy group substituted by an epoxy group; and the remaining R¹ represent a hydrogen atom, a C₁-C₁₀ alkyl group, a C₂-C₁₀ alkenyl group or a C₆-C₁₅ aryl group; and
R² represents a hydrogen atom, a C₁-C₆ alkyl group, a C₁-C₆ acyl group or a C₆-C₁₅ aryl group; and
the triazine-based compound (B) comprises a triazine-based compound (B-1) represented by Formula (2);

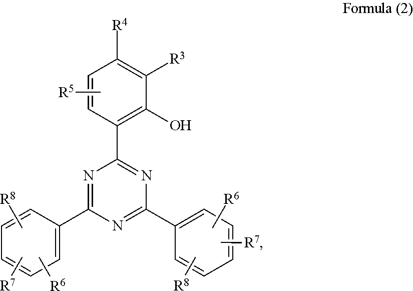

R³, R⁴, and R⁵ each independently represent a hydrogen atom, a halogen atom, an alkyl group or an alkoxy group; and
R⁶, R⁷, and R⁸ each independently represent a hydrogen atom, a halogen atom, an aryl group or an alkoxy group; and at least one of R⁶, R⁷, and R⁸ is not a hydrogen atom.

The present invention also provides a method for forming a thin film on a substrate comprising applying the curing resin composition as mentioned above on the substrate.

The present invention also provides a thin film on a substrate, which thin film is manufactured by the method as mentioned above.

The present invention further provides an apparatus comprising the thin film as mentioned above.

### DETAILED DESCRIPTION OF THE INVENTION

The present invention provides a curing resin composition comprising:
a polysiloxane (A);
a triazine-based compound (B); and
a solvent (C);
wherein:
the polysiloxane (A) comprises a polysiloxane (A-1) having an acid anhydride group or epoxy group, and the polysiloxane (A-1) is obtained by subjecting a reactant to hydrolysis and partial condensation, and the reactant includes at least one silane monomer having a structure of Formula (1):

Si(R¹)ₜ(OR²)₄₋ₜ Formula (1),
t represents an integer from 1 to 3; when t represents 2 or 3, a plurality of R¹ are independently the same or different; and when 4−t represents 2 or 3, a plurality of R² are independently the same or different;
at least one of R¹ represents a C₁-C₁₀ alkyl group substituted by an acid anhydride group, a C₁-C₁₀ alkyl group substituted by an epoxy group or an alkoxy group substituted by an epoxy group; and the remaining R¹ represent a hydrogen atom, a C₁-C₁₀ alkyl group, a C₂-C₁₀ alkenyl group or a C₆-C₁₅ aryl group; and
R² represents a hydrogen atom, a C₁-C₆ alkyl group, a C₁-C₆ acyl group or a C₆-C₁₅ aryl group; and
the triazine-based compound (B) comprises a triazine-based compound (B-1) represented by Formula (2);

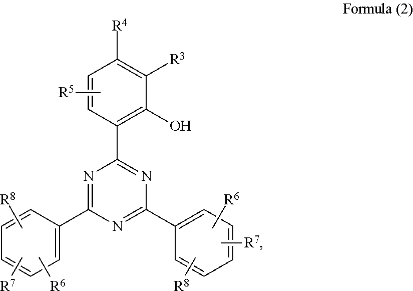

R³, R⁴, and R⁵ each independently represent a hydrogen atom, a halogen atom, an alkyl group or an alkoxy group; and
R⁶, R⁷, and R⁸ each independently represent a hydrogen atom, a halogen atom, an aryl group or an alkoxy group; and at least one of R⁶, R⁷, and R⁸ is not a hydrogen atom.

The polysiloxane (A) comprises a polysiloxane (A-1) having an acid anhydride group or epoxy group, and the polysiloxane (A-1) is obtained by subjecting a reactant to a polymerization reaction (that is hydrolysis and partial condensation), and the reactant includes silane monomer, siloxane prepolymer or a combination thereof.

The silane monomer includes at least one silane monomer having a structure of Formula (1):

Si(R¹)ᵣ(OR²)₄₋ₜ Formula (1),
t represents an integer from 1 to 3; when t represents 2 or 3, a plurality of R¹ are independently the same or different; and when 4-t represents 2 or 3, a plurality of R² are independently the same or different;
at least one of R¹ represents a C₁-C₁₀ alkyl group substituted by an acid anhydride group, a C₁-C₁₀ alkyl group substituted by an epoxy group or an alkoxy group substituted by an epoxy group; and the remaining R¹ represent a hydrogen atom, a C₁-C₁₀ alkyl group, a C₂-C₁₀ alkenyl group or a C₆-C₁₅ aryl group; and
R² represents a hydrogen atom, a C₁-C₆ alkyl group, a C₁-C₆ acyl group or a C₆-C₁₅ aryl group.

Examples of the C₁-C₁₀ alkyl group substituted by the acid anhydride group are ethyl succinic anhydride, propyl succinic anhydride or propyl glutaric anhydride, or the like.

Examples of the C₁-C₁₀ alkyl group substituted by the epoxy group are oxetanylpentyl, 2-(3,4-epoxycyclohexyl)ethyl, or the like.

Examples of the alkoxy group substituted by the epoxy group are glycidoxypropyl, 2-oxetanylbutoxy, or the like.

In R², the aforementioned alkyl group may include, but not limited to, a methyl group, ethyl group, n-propyl group, isopropyl group, n-butyl group, or the like. The acyl group may include, but not limited to, an acetyl group. The aryl group may include, but not limited to, a benzyl group.

The silane monomer having the structure represented by Formula (1) may include, but not limited to, 3-glycidoxypropyltrimethoxysilane (TMS-GAA), 3-glycidoxypropyltriethoxysilane, 2-(3,4-epoxycyclohexyl)ethyltrimethoxy silane, 2-oxetanylbutoxypropyltriphenoxysilane, 3-(triphenoxysilyl)propyl succinic anhydride, 3-(trimethoxysilyl)propyl glutaric anhydride (TMSG), 3-(triethoxysilyl)propyl glutaric anhydride, 3-(triphenoxysilyl)propyl glutaric anhydride, diisopropoxy-di(2-oxetanylbutoxypropyl)silane (DIDOS), di(3-oxetanylpentyl)dimethoxysilane, (di-n-butoxysilyl)di(propylsuccinic anhydride), (dimethoxysilyl)di(ethylsuccinic anhydride), 3-glycidoxypropyldimethylmethoxysilane, 3-glycidoxypropyldimethylethoxysilane, di(2-oxetanylbutoxypentyl)-2-oxetanylpentylethoxysilane, tri(2-oxetanylpentyl)methoxysilane, (phenoxysilyl)tri(propyl succinic anhydride), (methylmethoxysilyl)di(ethyl succinic anhydride); commercially available 2-oxetanylbutoxypropyltrimethoxysilane (the trade name is TMSOX-D), 2-oxetanybutoxypropyltriethoxysilane (the trade name is TESOX-D), 3-ethyl-3-{[3-(trimethoxysilyl)propoxy]methyl}epoxypropane (the trade name is TMSOX) manufactured by Toagosei Co. Ltd.; commercially available 3-trimethoxysilylpropyl succinic anhydride (the trade name is X-12-967) manufactured by Shin-Etsu Chemical Co., Ltd.; and commercially available 3-(triethoxysilyl)propyl succinic anhydride (the trade name is GF-20) manufactured by Wacker Chemie AG, or the like. The aforementioned silane monomer having the structure represented by Formula (1) can be used alone or in admixture of two or more thereof.

Preferably, the silane monomer may include, but not limited to, a silane monomer having a structure represented by Formula (1-1):

Si(R⁹)ᵤ(OR¹⁰)₄₋ᵤ Formula (1-1)
wherein:
R⁹ is selected from a group consisting of a hydrogen atom, a C₁-C₁₀ alkyl group, a C₂-C₁₀ alkenyl group and a C₆-C₁₅ aryl group, wherein the C₁-C₁₀ alkyl group does not comprise an acid anhydride group substitution;
R¹⁰ is independently selected from a group consisting of a hydrogen atom, a C₁-C₆ alkyl group, a C₁-C₆ acyl group and a C₆-C₁₅ aryl group; and
u represents an integer from 1 to 3; when u represents 2 or 3, a plurality of R⁹ are independently the same or different; and when 4−u represents 2, 3 or 4, a plurality of R¹⁰ are independently the same or different.

In R⁹, the alkyl group may include, but not limited to, a methyl group, ethyl group, n-propyl group, isopropyl group, n-butyl group, tert-butyl group, n-hexyl group, n-decyl group, trifluoromethyl group, 3,3,3-trifluoropropyl group, 3-aminopropyl group, 3-mercaptopropyl group, 3-isocyanatopropyl group, or the like. The alkenyl group may include, but not limited to, a vinyl group, 3-acryloxypropyl group, 3-methacryloxypropyl group, or the like. The aryl group may include, but not limited to, a phenyl group, tolyl group, p-hydroxyphenyl group, 1-(p-hydroxyphenyl)ethyl group, 2-(p-hydroxyphenyl)ethyl group, 4-hydroxy-5-(p-hydroxyphenylcarbonyloxy)pentyl group, naphthyl group, or the like.

In R¹⁰, the alkyl group may include, but not limited to, a methyl group, ethyl group, n-propyl group, isopropyl group, n-butyl group, or the like. The acyl group may include, but not limited to, an acetyl group. The aryl group may include, but not limited to, a phenyl group.

The silane monomer having the structure represented by Formula (1-1) may include, but not limited to, tetramethoxysilane, tetraethoxysilane, tetraacetoxysilane, tetraphenoxysilane, methyltrimethoxysilane, methyltriethoxysilane, methyltriisopropoxysilane, methyltri-n-butoxysilane, ethyltrimethoxysilane, ethyltriethoxysilane, ethyltriisopropoxysilane, ethyltri-n-butoxysilane, n-propyltrimethoxysilane, n-propyltriethoxysilane, n-butyltrimethoxysilane, n-butyltriethoxysilane, n-hexyltrimethoxysilane, n-hexyltriethoxysilane, decyltrimethoxysilane, vinyltrimethoxysilane, vinyltriethoxysilane, phenyltrimethoxysilane, phenyltriethoxysilane, hydroxyphenyltrimethoxysilane, 1-(p-hydroxyphenyl)ethyltrimethoxysilane, 2-(p-hydroxyphenyl)ethyltrimethoxysilane, 4-hydroxy-5-(p-hydroxyphenylcarbonyloxy)pentyltrimethoxysilane, trifluoromethyltrimethoxysilane, trifluoromethyltriethoxysilane, 3,3,3-trifluoropropyltrimethoxysilane, 3-aminopropyltrimethoxysilane, 3-aminopropyltriethoxysilane, dimethyldimethoxysilane, dimethyldiethoxysilane, dimethyldiacetyloxysilane, di-n-butyldimethoxysilane, diphenyldimethoxysilane, trimethylmethoxysilane, tri-n-butylethoxysilane, 3-mercaptopropyltrimethoxysilane, 3-acryloxypropyltrimethoxysilane, 3-methylacryloxypropyltrimethoxysilane, 3-methylacryloxypropyltriethoxysilane, or the like. The aforementioned silane monomer having the structure represented by Formula (1-1) can be used alone or in admixture of two or more thereof.

Preferably, the above-mentioned polysiloxane (A-1) having the acid anhydride group or epoxy group may include a siloxane prepolymer having a structure represented by Formula (1-2):

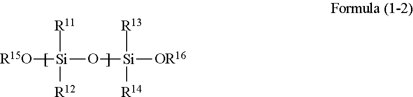

wherein:
R¹¹, R¹², R¹³ and R¹⁴ are the same or different, and are independently selected from a group consisting of a hydrogen atom, a C₁-C₁₀ alkyl group, a C₂-C₆ alkenyl group and a C₆-C₁₅ aryl group; wherein preferably, the alkyl group, the alkenyl group or the aryl group comprises a substituted group; wherein each of R¹¹ is the same or different, and each of R¹² is the same or different; the aforementioned alkyl group may include, but not limited to, a methyl group, ethyl group, n-propyl group, or the like. The aforementioned alkenyl group may include, but not limited to, a vinyl group, acryloxypropyl group, methacryloxypropyl group, or the like. The aforementioned aryl group may include, but not limited to, a phenyl group, tolyl group, naphthyl group, or the like.
s represents an integer from 1 to 1000; preferably, s represents an integer from 3 to 300; more preferably, s represents an integer from 5 to 200.

R¹⁵ and R¹⁶ are independently selected from a group consisting of a hydrogen atom, a C₁-C₆ alkyl group, a C₁-C₆ acyl group and a C₆-C₁₅ aryl group; wherein preferably, the alkyl group, the aryl group or the aryl group comprises a substituted group. Preferably, the alkyl group may include, but not limited to, a methyl group, ethyl group, n-propyl group, isopropyl group, n-butyl group, or the like. The acyl group may include, but not limited to, an acetyl group. The aryl group may include, but not limited to, a phenyl group.

The siloxane prepolymer having the structure represented by Formula (1-2) may include, but not limited to, 1,1,3,3-tetramethyl-1,3-dimethoxydisiloxane, 1,1,3,3-tetramethyl-1,3-diethoxydisiloxane, 1,1,3,3-tetraethyl-1,3-diethoxydisiloxane or commercially available silanol terminal polysiloxanes manufactured by Gelest Inc., for example, DM-S12 (molecular weight: 400-700), DMS-S15 (molecular weight: 1,500-2,000), DMS-S21 (molecular weight: 4,200), DMS-S27 (molecular weight: 18,000), DMS-S31 (molecular weight: 26,000), DMS-S32 (molecular weight: 36,000), DMS-S33 (molecular weight: 43,500), DMS-S35 (molecular weight: 49,000), DMS-S38 (molecular weight: 58,000), DMS-S42 (molecular weight: 77,000), PDS-9931 (molecular weight: 1,000-1,400), or the like. The aforementioned polysiloxane having the structure represented by Formula (1-2) can be used alone or in admixture of two or more thereof.

Preferably, the aforementioned reactant can selectively include silicon dioxide particles. There is no specific limitation to the mean particle size of the silicon dioxide particles, and the mean particle size is from 2 nm to 250 nm, preferably is from 5 nm to 200 nm and more preferably is from 10 nm to 100 nm.

The silicon dioxide particles may include, but not limited to, commercially available products manufactured by JGC Catalysts and Chemicals Ltd., and the trade names are OSCAR 1132 (particle size: 12 nm, dispersant: methanol), OSCAR 1332 (particle size: 12 nm, dispersant: n-propanol), OSCAR 105 (particle size 60 nm, dispersant: γ-butyrolactone), OSCAR 106 (particle size: 120 nm, dispersant: diacetone alcohol), or the like; commercially available products manufactured by Fuso Chemical Co., Ltd., and the trade names are Quartron PL-1-IPA (particle size: 13 nm, dispersant: isopropanone), Quartron PL-1-TOL (particle size: 13 nm, dispersant: toluene), Quartron PL-2L-PGME (particle size: 18 nm, dispersant: propylene glycol monomethyl ether), Quartron PL-2L-MEK (particle size: 18 nm, dispersant: methyl ethyl ketone), or the like; and commercially available products manufactured by Nissan Chemical Co. Ltd., and the trade names are IPA-ST (particle size: 12 nm, dispersant: isopropanol), EG-ST (particle size: 12 nm, dispersant: ethylene glycol), IPA-ST-L (particle size: 45 nm, dispersant: isopropanol), IPA-ST-ZL (particle size: 100 nm, dispersant: isopropanol), or the like. The aforementioned examples of the silicon dioxide particles can be used alone or in admixture of two or more thereof.

The aforementioned partial condensation can be performed in a manner well known in the art. For example, a solvent, water, and optionally a catalyst are added to the silane monomer, followed by stirring at 50° C. to 150° C. for 0.5 to 120 hours. During stirring, the by-products (such as alcohols and water) can be removed by distillation.

There is no specific limitation to the aforementioned solvent, which can be the same or different from the solvent (C) in the curing resin composition according to the invention. Based on the silane monomer as 100 g, the amount of the solvent is 15 g to 1200 g, preferably is 20 g to 1100 g, and more preferably is 30 g to 1000 g.

Based on the hydrolysable groups in the silane monomer as 1 mole, the amount of water used for the hydrolysis is 0.5 moles to 2 moles.

There is no specific limitation to the aforementioned catalyst, and preferably an acid catalyst or a base catalyst can be selected. The acid catalyst may include, but not limited to, hydrochloric acid, nitric acid, sulfuric acid, hydrofluoric acid, oxalic acid, phosphoric acid, acetic acid, trifluoroacetic acid, formic acid, polycarboxylic acids or anhydrides thereof, ion exchange resins, or the like. The base catalyst may include, but not limited to, diethylamine, triethylamine, tripropylamine, tributylamine, tripentylamine, trihexylamine, triheptylamine, trioctylamine, diethanolamine, triethanolamine, sodium hydroxide, potassium hydroxide, alkoxysilanes having an amino group, ion exchange resins, or the like.

Based on the silane monomer as 100 g, the amount of the catalyst is 0.005 g to 15 g, preferably is 0.01 g to 12 g, and more preferably is 0.05 g to 10 g.

In view of the stability, it is preferred that the polysiloxane having the acid anhydride group or epoxy group (A-1) produced after condensation contains no by-products (for example, alcohols or water) and catalysts; therefore the polysiloxane having the acid anhydride group or epoxy group (A-1) produced can be optionally purified. There is no specific limitation to the purification method, preferably, the polysiloxane having the acid anhydride group or epoxy group (A-1) can be diluted with a hydrophobic solvent, and the organic layer that has been washed with water several times is then concentrated with an evaporator to remove the alcohols and water. Additionally, the catalyst can be removed by using an ion exchange resin.

Based on 100 parts by weight of the used amount of the polysiloxane (A), the used amount of the polysiloxane (A-1) having the acid anhydride group or epoxy group is from 30 to 100 parts by weight; preferably is from 40 to 100 parts by weight; and more preferably is from 50 to 100 parts by weight. If the polysiloxane (A-1) is absent, the curing resin composition has a defect of poor adhesion and coating properties.

Though not willing to be limited by theory, it is believed that because the acid anhydride group or epoxy group can form a covalent bond with the substrate, and it can improve the adhesion property; and since the polarity of the acid anhydride group or epoxy group is similar to that of the substrate, the polysiloxane has good coating property.

In one preferred embodiment of the invention, the curing resin composition further comprises an acrylic acid resin (A′). In one preferred embodiment of the invention, the acrylic acid resin (A′) is polymerized by a mixture of an unsaturated compound. The unsaturated compound can be an unsaturated carboxylic acid compound, an unsaturated carboxylic acid anhydride compound, an unsaturated compound having an epoxy group or other unsaturated compound. Examples of the aforementioned acrylic acid resin are ARUFON UC-3910, ARUFON UH-2032 (manufactured by Toagosei Co. Ltd.).

The triazine-based compound (B) according to the present invention comprises a triazine-based compound (B-1) represented by Formula (2);

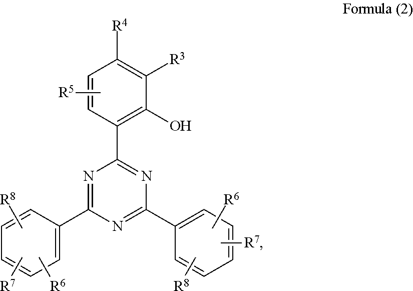

R³, R⁴, and R⁵ each independently represent a hydrogen atom, a halogen atom, an alkyl group or an alkoxy group; and
R⁶, R⁷, and R⁸ each independently represent a hydrogen atom, a halogen atom, an aryl group or an alkoxy group; and at least one of R⁶, R⁷, and R⁸ is not a hydrogen atom.

Examples of the triazine-based compound (B-1) are 2,4-di-p-tolyl-6-(2-hydroxy-4-methoxyphenyl)-1,3,5-triazine, 2,4-di-p-tolyl-6-(2-hydroxy-4-propoxyphenyl)-1,3,5-triazine, 2,4-di-p-tolyl-6-(2-hydroxy-4-butoxyphenyl)-1,3,5-triazine, 2,4-di-p-tolyl-6-(2-hydroxy-4-hexyloxyphenyl)-1,3,5-triazine, 2,4-di-p-tolyl-6-(2-hydroxy-4-pentoxyphenyl)-1,3,5-triazine, 2,4-di-p-tolyl-6-(2-hydroxy-4-octoxyphenyl)-1,3,5-triazine, 2,4-di-p-tolyl-6-(2-hydroxy-4-benzyloxyphenyl)-1,3,5-triazine, 2,4-di-p-tolyl-6-(2-hydroxy-4-(2-hexyloxyethoxyl)phenyl)-1,3,5-triazine, 2-[4-[(2-hydroxy-3-dodecyloxypropyl)oxy]-2-hydroxyphenyl]-4,6-bis(2,4-dimethylphenyl)-1,3,5-triazine, 2-[4-[(2-hydroxy-3-tridecyloxypropyl)oxy]-2-hydroxyphenyl]-4,6-bis(2,4-dimethylphenyl)-1,3,5-triazine (TINUVIN 400, manufactured by Ciba Co. Ltd.), 2-[4-[(2-hydroxy-3-(2′-ethyl)hexyl)oxy]-2-hydroxyphenyl]-4,6-bis(2,4-dimethylphenyl)-1,3,5-triazine (TINUVIN 405, manufactured by Ciba Co. Ltd.), 2,4-bis(2-hydroxy-4-butoxyphenyl)-6-(2,4-bis-butoxyphenyl)-1,3,5-triazine (TINUVIN 460, manufactured by Ciba Co. Ltd.) or 2-(2-hydroxy-4-(1-octyloxyethoxycarbonyl)phenyl)-4,6-bis(4-phenylphenyl)-1,3,5-triazine (TINUVIN 479, manufactured by Ciba Co. Ltd.); preferably is TINUVIN 400, TINUVIN 405, TINUVIN 460 and TINUVIN 479.

The triazine-based compound (B) according to the present invention can further comprise an other triazine-based compound (B-2). Examples of the other triazine-based compound (B-2) are 2,4-diphenyl-6-(2-hydroxy-4-methoxyphenyl)-1,3,5-triazine, 2,4-diphenyl-6-(2-hydroxy-4-ethoxyphenyl)-1,3,5-triazine, 2,4-diphenyl-6-(2-hydroxy-4-propoxyphenyl)-1,3,5-triazine, 2,4-diphenyl-6-(2-hydroxy-4-butoxyphenyl)-1,3,5-triazine, 2,4-diphenyl-6-(2-hydroxy-4-pentyloxyphenyl)-1,3,5-triazine, 2,4-diphenyl-6-(2-hydroxy-4-hexyloxyphenyl)-1,3,5-triazine, 2,4-diphenyl-6-(2-hydroxy-4-octyloxyphenyl)-1,3,5-triazine, 2,4-diphenyl-6-(2-hydroxy-4-dodecyloxyphenyl)-1,3,5-triazine, 2,4-diphenyl-6-(2-hydroxy-4-benzyloxyphenyl)-1,3,5-triazine or 2,4-diphenyl-6-(2-hydroxy-4-(2-butoxyethoxy)phenyl)-1,3,5-triazine.

Based on 100 parts by weight of the used amount of the polysiloxane (A), the used amount of the triazine-based compound (B) is from 0.3 to 5 parts by weight; preferably is from 0.4 to 4.5 parts by weight; and more preferably is from 0.5 to 4 parts by weight.

Based on 100 parts by weight of the used amount of the polysiloxane (A), the used amount of the triazine-based compound (B-1) is from 0.1 to 3 parts by weight; preferably is from 0.2 to 2.5 parts by weight; and more preferably is from 0.3 to 2 parts by weight. If the triazine-based compound (B-1) is absent, the curing resin composition has a defect of poor adhesion property.

Though not willing to be limited by theory, it is believed that because the triazine-based compound (B-1) can absorb free radicals at a high temperature and avoid the polymer from being lysed. In particular, the triazine-based compound can inhibit free radicals to destroy the covalent bond between the polymer and the substrate; hence it can improve the adhesion property.

The solvent (C) according to the present invention can be completely dissolved with other organic components and its volatility has to high enough so that it can evaporate from the dispersion at atmospheric pressure with only little heat needed, especially the solvent with the boiling point under 150° C. is preferred.

Examples of the solvent (C) are benzene, toluene and xylene; alcohols such as methanol, ethanol or the like; ethers such as ethylene glycol monopropyl ether, diglyme, tetrahydrofuran, ethylene glycol monomethyl ether, ethylene glycol monoethyl ether, diethylene glycol methyl ether, diethylene glycol ethyl ether, diethylene glycol butyl ether or the like; esters such as ethylene glycol methyl ether acetate, ethylene glycol ethyl ether acetate, propylene glycol methyl ether acetate, propylene glycol ethyl ether acetate, propylene glycol propyl ether acetate, 3-ethoxypropionate, 2-(2-ethoxyethoxyl)ethyl acetate or the like; ketones such as methylethyl ketone, acetone, 4-hydroxy-4-methyl-2-pentanone or the like.

Preferably, the solvent (C) is diethylene glycol methyl ether, propylene glycol methyl ether acetate, 3-ethoxypropionate, 2-(2-ethoxyethoxyl)ethyl acetate, or 4-hydroxy-4-methyl-2-pentanone which can be used alone or in admixture of two thereof. The curing resin composition comprising the solvent (C) has better storage stability.

Based on 100 parts by weight of the used amount of the polysiloxane (A), the used amount of the solvent (C) is from 100 to 1000 parts by weight; preferably is from 120 to 900 parts by weight; and more preferably is from 150 to 800 parts by weight.

In one preferred embodiment of the invention, the curing resin composition further comprises a polydimethylsiloxane (D) comprising an alkoxy group represented by Formula (3);

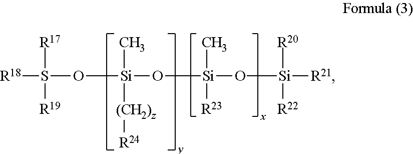

R¹⁷, R¹⁸, R¹⁹, R²⁰, R²¹, R²² and R²³ each independently represent a hydrogen atom, —CH³, —C²H⁵, —C³H⁷, —OCH³ or −OC²H⁵; preferably is —CH³, —C²H⁵, —OCH³ or —OC²H⁵; and more preferably is —CH³, or —C²H⁵;
x, y and z independently represent an integer from 1 to 20; preferably is from 1 to 10; and more preferably is from 1 to 5; and
R²⁴ represents a group represented by Formula (4) or Formula (5);

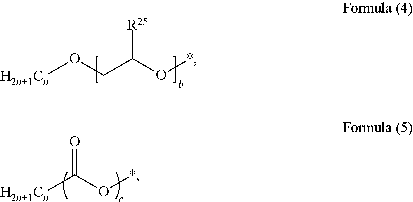

in Formula (4), R²⁵ represents a hydrogen atom, a C₁-C₄ alkyl group, a cation polymerizable group or an ethylenically unsaturated group; examples of the cation polymerizable group are epoxy group or oxetane; examples of the ethylenically unsaturated group are vinyl group, acryloyl group or methyl acryloyl group; R²⁵ preferably is a hydrogen atom or a C₁-C₄ alkyl group; and more preferably is a hydrogen atom;
n represents an integer from 1 to 5 in Formula (4) and Formula (5); and preferably is from 1 to 3; and
b and c represent an integer from 1 to 20 independently in Formula (4) and Formula (5); preferably is from 1 to 10 independently; and more preferably is from 1 to 5 independently.

In one preferred embodiment of the invention, R¹⁷, R¹⁸, R¹⁹, R²⁰, R²¹, R²² and R²³ each independently represent —CH₃, or —C₂H₅ in Formula (3); x, y and z independently represent an integer from 1 to 10; and R represents a group represented by Formula (6) or Formula (7);

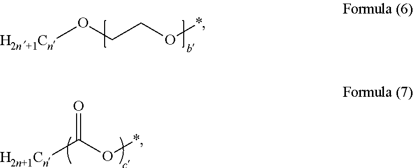

n′ represents an integer from 1 to 3 in Formula (6) and Formula (7); and
b′ and c′ represent an integer from 1 to 10 independently in Formula (6) and Formula (7).

In one preferred embodiment of the invention, the polydimethylsiloxane (D) comprising the alkoxy group represented by Formula (3) is a compound represented by Formula (8):

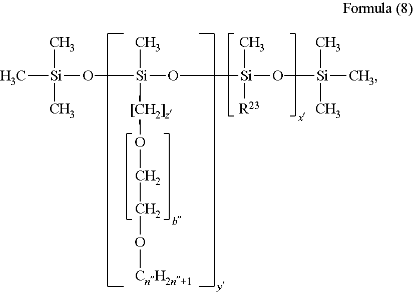

x′, y′, z′ and b′ independently represent an integer from 1 to 5; and
n″ represents an integer from 1 to 3.

Preferred examples of the polydimethylsiloxane (D) comprising the alkoxy group represented by Formula (3) are BYK-300, BYK-306, BYK-307, BYK-310, BYK-330, BYK-331, BYK-333, BYK-337, BYK-341, BYK-344, BYK-378 (above-mentioned all manufactured by Large Chemical Japan Co., Ltd.), Guranoru 410 (manufactured by Kyoeisha Chemical Co., Ltd.) or KF-351 (manufactured byShin-Etsu Chemical Co., Ltd.). The aforementioned compounds can be used alone or in admixture of two thereof.

Based on 100 parts by weight of the used amount of the polysiloxane (A), the used amount of the polydimethylsiloxane (D) comprising the alkoxy group represented by Formula (3) is from 0.01 to 1 parts by weight; preferably is from 0.03 to 0.8 parts by weight; and more preferably is from 0.05 to 0.5 parts by weight. If the polydimethylsiloxane (D) comprising the alkoxy group represented by Formula (3) is used, it can further improve the coating property.

Though not willing to be limited by theory, it is believed that because the polydimethylsiloxane (D) comprising the alkoxy group represented by Formula (3) having lower polarity which can reduce the surface tension, it increases wettability to the substrate and improves the coating property.

In one preferred embodiment of the invention, the curing resin composition further comprises an adhesion promoting agent (E).

Examples of the adhesion promoting agent (E) are vinyltrimethoxysilane, vinyltriethoxysilane, vinyltris(2-methoxyethoxy)silane, N-(2-aminoethyl)-3-aminopropylmethyldimethoxysilane, N-(2-aminoethyl)-3-aminopropyltrimethoxysilane, 3-aminopropyltriethoxysilane, 3-glycidoxypropyltrimethoxysilane, 3-glycidoxypropylmethyldiethoxysilane, 3-glycidoxypropylmethyldimethoxysilane, 2-(3,4-epoxycyclohexyl)ethyltrimethoxysilane, 3-chloropropylmethyldimethoxysilane, 3-chloropropyltrimethoxysilane, 3-methacryloyloxypropyl trimethoxysilane, 3-mercaptopropyltrimethoxysilane and 3-epoxypropoxypropyl trimethoxysilane (trade name KBM403, manufactured by Shin-Etsu Chemical Co., Ltd.) or any combination thereof.

Based on 100 parts by weight of the used amount of the polysiloxane (A), the used amount of the adhesion promoting agent (E) is from 0.5 to 6 parts by weight; preferably is from 0.8 to 5.5 parts by weight; and more preferably is from 1 to 5 parts by weight. If the adhesion promoting agent (E) is used, it can further improve the adhesion property.

In one preferred embodiment of the invention, the curing resin composition further comprises an additive (F). The additive (F) may include, but not limited to, a filler, a polymer compound (except for the aforementioned polysiloxane (A)), an anti-coagulant, a stabiliser, or a heat resistance accelerant.

Examples of the aforementioned filler may include, but not limited to, glass or aluminium.

Examples of the polymer compound except for the aforementioned polysiloxane (A) may include, but not limited to, polyvinyl alcohol, polyethylene glycol monoalkyl ether, polyfluoro alkyl acrylate.

Examples of the aforementioned anti-coagulant may include, but not limited to, sodium polyacrylate.

Examples of the aforementioned stabiliser may include, but not limited to, sulfur, quinone, hydroquinone, polyoxides, amines, nitroso compound or a nitro group. Examples of the stabiliser may include, but not limited to, 4-methoxyphenol, (N-nitroso-N-phenyl) hydroxylamine Aluminium, 2-2-thiobis(4-methyl-6-tertiarybutylphenol) and 2,6-di-tertiarybutylphenol.

Examples of the aforementioned heat resistance accelerant may include, but not limited to, N-(alkoxymethyl)glycoluril compound, or N-(alkoxymethyl)melamine. Examples of the N-(alkoxymethyl)glycoluril compound may include, but not limited to, N,N,N′,N′-tetra(methoxymethyl)glycoluril, N,N,N′,N′-tetra(ethoxymethyl)glycoluril, N,N,N′,N′-tetra(n-propoxymethyl)glycoluril, N,N,N′,N′-tetra(isopropoxymethyl)glycoluril, N,N,N′,N′-tetra(n-butoxymethyl)glycoluril, N,N,N′,N′-tetra(tert-butoxymethyl)glycoluril; preferably is N,N,N′,N′-tetra(methoxymethyl)glycoluril; and examples of the N-(alkoxymethyl)melamine may include, but not limited to, N,N,N′,N′,N″,N″-hexa(methoxymethyl)melamine, N,N,N′,N′,N″,N″-hexa(ethoxymethyl)melamine, N,N,N′,N′,N″,N″-hexa(n-propoxymethyl)melamine, N,N,N′,N′,N″,N″-hexa(isopropoxymethyl)melamine, N,N,N′,N′,N″,N″-hexa(n-butoxymethyl)melamine, N,N,N′,N′,N″,N″-hexa(tert-butoxymethyl)melamine; more preferably is N,N,N′,N′,N″,N″-hexa(methoxymethyl)melamine. Examples of the commercially available products are NIKARAKKU N-2702 and MW-30M (manufactured by Sanho Chemical Co., Ltd.).

Based on 100 parts by weight of the used amount of the polysiloxane (A), the used amount of the additive (F) is from 0 to 10 parts by weight; preferably is from 0 to 6 parts by weight; and more preferably is from 0 to 3 parts by weight. In general, the used amount of the additive (F) can be adjusted by artisans skilled in this field according to the experiment; hence the used amount of the additive (F) is not limited to the aforementioned.

The curing resin composition according to the present invention can be prepared in the following manner: placing the polysiloxane (A), the triazine-based compound (B) and the solvent (C) in a blender and stirring them until homogeneously mixed into a solution state. If necessary, the polydimethylsiloxane (D) comprising the alkoxy group represented by Formula (3), the adhesion promoting agent (E) and/or the additive (F) can be added. After homogeneously mixed, the solution state of the curing resin composition is obtained.

The present invention also provides a method for forming a thin film on a substrate comprising applying the curing resin composition as mentioned above on the substrate.

The present invention also provides a thin film on a substrate, which is manufactured by the method as mentioned above.

Preferably, the thin film is a protective film in a color filter layer.

The method of forming the thin film comprising: coating the aforementioned curing resin composition on a substrate, and then removing the solvent in the curing resin composition by pre-baking. After the above process, the thin film in the color filter layer is formed.

Examples of the substrate are glass, quartz, silicon, resin or the like. Examples of the resin may include, but not limited to, a polymer obtained by a ring-opening reaction with polyethylene terephalate, polyethylene terephalate, polyethersulfone, polycarbonate, polyimide, cyclic olefin or the like.

Examples of the coating method are spray, roller coating, spin coating, bar coating, ink jet or the like. Preferably, the coating method can adopt a spin coater, a spin loess coating machine and a slit-die coating machine.

The operation condition of the above-mentioned pre-baking may be different from the kinds of component and ratio. Generally, pre-baking is at a temperature between 70° C. to 110° C. for 1 minute to 15 minutes. After the pre-baking process, the thickness of the pre-baked coating film is from 0.15 to 8.5 μm; preferably is from 0.15 to 6.5 μm; and more preferably is from 0.15 to 4.5 μm. The thickness of the pre-baked coating film refers to the thickness after removal of the solvent.

After forming the pre-baking coating film, the pre-baking coating film is heated on a heating plate or in an oven. The heating temperature is set between 100° C. to 250° C., and the heating time with the heating plate is 5 to 30 minutes or the heating time with the oven is 5 to 30 minutes.

The thickness of the above-mentioned thin film in the color filter layer is 0.1 to 8 μm; preferably is from 0.1 to 6 μm; and more preferably is from 0.1 to 4 μm. When the height of the thin film forming on the substrate is different from the color filter layer, the above-mentioned thickness of the thin film refers to the thickness measured on the surface of the color filter layer.

The following examples specify that the thin film according to the present invention can satisfy the coating property, surface hardness, transparency, heat resistance, light resistance, and solvent resistance at the same time. The thin film according to the present invention can sustain the weight without depression under a heating state, and when the height of the thin film is different from the color filter layer on an underneath substrate, the thin film can provide planarization; therefore, the thin film is suitable for optical instruments as a protective film.

In particular, the protective film according to the present invention has good adhesion and coating property.

The present invention further provides an apparatus comprising the aforementioned thin film.

Preferably, the apparatus is a liquid crystal display element.

The liquid crystal display element according to the invention can be formed by the following method: forming a protective film on at least one side or two sides of a transparent substrate formed with a color filter layer with the curing resin composition according to the aforementioned method. Then, placing a cell gap between the transparent substrate with the color filter layer and the protective film and a driving substrate with a thin film transistor (TFT) placed opposite to each other, wherein the side of the substrate has an alignment film is taken as an interior side.

Then, sealing the surrounding area of the two substrates with a sealing agent. Next, injecting liquid crystals into a space separated by the surface of the substrates and the sealing agent. Sealing the injection hole and forming liquid crystal cells. Then, laminating a polarizer to the outer surface of the liquid crystal cells, i.e. the other side surfaces of each of the substrates forming the liquid crystal cell, so as to fabricate the liquid crystal display element.

Another laminated method is to coat a UV-curing adhesive along one endpoint of the substrate, and to drop the micro liquid crystal on the substrate by a liquid crystal splitter; then, to stack with another substrate under a vacuum condition, and to laminate under a high-pressure mercury lamp irradiation which can emit UV light. Then, a polarizer is laminated to the inner and outer surface of the liquid crystal so as to fabricate the liquid crystal display element.

The liquid crystal can be a liquid crystal compound or a liquid crystal composition. The specific composition of the liquid crystal is not particularly limited, and any liquid crystal compound and liquid crystal composition known by those skilled in the art can be used.

Moreover, the liquid crystal alignment film is used to limit the alignment of the liquid crystal molecules and is not particularly limited, and can be any inorganic matter or organic matter. Furthermore, the technique of forming the liquid crystal alignment film is well known by those skilled in the art and is thus not repeated herein.

The following examples are given for the purpose of illustration only and are not intended to limit the scope of the present invention.

<Preparations>

Preparation of Polysiloxane (A):

Preparation A-1-1

Following adding 0.30 mole of methyltrimethoxysilane (hereinafter referred to as MTMS), 0.45 mole of phenyltrimethoxysilane (hereinafter referred to as PTMS), 0.05 mole of 3-(triethoxysilyl) propyl succinic anhydride (hereinafter referred to as GF-20), 0.2 mole of 3-(trimethoxysilyl)propyl methacrylate (hereinafter referred to KBM-503) and 180 g 4-hydroxy-4-methyl-2-pentanone (hereinafter referred to DAA) into a 500 ml three-necked flask, an aqueous oxalic acid solution (0.40 g oxalic acid/75 g water) was added at room temperature with stirring within 30 minutes. Next, the flask was immersed at 30° C. in oil bath and stirred for 30 minutes. Then, the temperature of the oil bath was raised to 110° C. After 6 hours, the solvent was removed using distillation to obtain the polysiloxane A-1-1.

Preparations A-1-2 to A-2-2

Preparations A-1-2 to A-2-2 were conducted in a manner identical to that of Preparation A-1-1 with different reaction conditions as well as altered ingredients and amounts which are illustrated in Table 1.

TABLE 1

| | Composition | | | | | | | | | | | | | | | |
|---|---|---|---|---|---|---|---|---|---|---|---|---|---|---|---|---|
| | silane monomer/polysiloxane (mol) | | | | | | | | | | | | | | | |
| | | | | | GF- | | | TMS- | DMS- | KBM- | Solvent (g) | | | Oxalic | Temp. | Time |
| Preparation | MTMS | DMDMS | PTMS | PTES | 20 | TMSG | TMSOX | GAA | S27 | 503 | PGEE | DAA | water | acid | (° C. ) | (hour) |
| A-1-1 | 0.30 | | 0.45 | | 0.05 | | | | | 0.20 | | 180 | 75 | 0.4 | 110 | 6 |
| A-1-2 | | 0.45 | | 0.50 | | 0.04 | | | 0.01 | | 100 | 100 | 75 | 0.35 | 105 | 6 |
| A-1-3 | 0.62 | | 0.19 | 0.16 | | | 0.03 | | | | 160 | | 75 | 0.5 | 120 | 6 |
| A-1-4 | | 0.30 | 0.20 | 0.48 | | | | 0.02 | | | | 200 | 75 | 0.35 | 110 | 6 |
| A-1-5 | 0.33 | 0.26 | 0.34 | | 0.03 | 0.04 | | | | | 200 | | 75 | 0.4 | 110 | 6 |
| A-1-6 | 0.40 | | 0.42 | | 0.02 | | 0.06 | | | 0.10 | | 160 | 75 | 0.4 | 110 | 6 |
| A-2-1 | 0.40 | | 0.60 | | | | | | | | | 200 | 75 | 0.4 | 110 | 6 |
| A-2-2 | 0.30 | | 0.50 | 0.20 | | | | | | | 200 | | 75 | 0.4 | 110 | 6 |

| | |
|---|---|
| MTMS | methyltrimethoxysilane |
| DMDMS | dimethyldimethoxysilane |
| PTMS | phenyltrimethoxysilane |
| PTES | phenyltriethoxysilane |
| GF-20 | 3-(triethoxysilyl)propyl succinic anhydride |
| TMSG | 3-(trimethoxysilyl)propyl glutaric anhydride |
| TMSOX | 3 -ethyl-3-{[3-(trimethoxysilyl)propoxy]methyl} epoxypropane |
| TMS-GAA | 3-glycidoxypropyltrimethoxysilane |
| DMS-S27 | the silanol end portion of polysiloxane (manufactured by Gelest Co., Ltd.) |
| KBM-503 | 3-(trimethoxysilyl)propyl methacrylate |
| PGEE | propylene glycol monoethyl ether |
| DAA | 4-hydroxy-4-methyl-2-pentanone |

### EXAMPLES

The following Examples 1 to 8 and Comparative Examples 1 to 5 were practiced according to Table 2 and Table 3.

### Example 1

One-hundred parts by weight of the used amount of the polysiloxane A-1-1, 0.1 parts by weight of 2,4-di-p-tolyl-6-(2-hydroxy-4-propoxyphenyl)-1,3,5-triazine (hereinafter referred to B-1-1), 0.2 parts by weight of 2,4-diphenyl-6-(2-hydroxy-4-methoxyphenyl)-1,3,5-triazine (hereinafter referred to B-2-1), 0.01 parts by weight of BYK-331 (hereinafter referred to D-1), 0.5 parts by weight of vinyltrimethoxysilane (hereinafter referred to E-1) and 100 parts by weight of 4-hydroxy-4-methyl-2-pentanone (hereinafter referred to C-1) were added in a shaking agitator, mixed and dissolved completely, so as to form the curing resin composition. The compositions and the results of the assays are shown in Table 2.

### Examples 2 to 8 and Comparative Examples 1 to 5

Examples 2 to 8 and Comparative Examples 1 to 5 were conducted in a manner identical to that of Example 1 with different reaction conditions as well as altered ingredients and amounts which are illustrated in Tables 2 and 3.

Formation of Thin Film

Various polysiloxane compositions were spin coated independently on a prime glass substrate of 100×100×0.7 mm in size, and then pre-baked for 2 minutes at 90° C. to obtain a pre-baked coating film of about 2 μm in thickness. Then, the film was post-baked for 30 minutes at 245° C., so as to form the film on the prime glass substrate.

Assays

(1) Adhesion Property

The aforementioned thin film was irradiated by an ultraviolet light (exposure machine model: AG500-4N; manufactured by M&R Nano Technology) for 180 minutes at an energy density of 80 mW/cm², wavelength 200 to 800 nm, and then the thin film was sliced into 100 base plate meshes according to 8.5.2 base plate mesh method of JIS.5400 (1900) 8.5 adhesion test method, tearing with the stick tape and then observed the residual base plate meshes. The criteria of the assay are shown blow:
⊚: 5B;
◯: 4B;
Δ: 3B to 2B; and
X: 1B to 0B;
wherein, 5B, none of the base plate meshes falling off;
4B, 0%<the number of the falling off base plate meshes≦5%;
3B, 5%<the number of the falling off base plate meshes≦15%;
2B, 15%<the number of the falling off base plate meshes≦35%;
1B, 35%<the number of the falling off base plate meshes≦65%;
0B, 65%<the number of the falling off base plate meshes≦100%. (2) Coating Property

The curing resin composition was coated on a 100 mm×100 mm of rectangular glass substrate to form an 80 mm×80 mm of coating film with a screen printing machine (manufactured by ATMA CHAMP ENT. Co., AT-45PA) and then observed the surface of the coating film. The criteria of the assay are shown blow:
⊚: after coating the surface showed a flat shape, no irregular lines appear
◯: after coating the surface showed a flat shape, but a few irregular lines appear
Δ: after coating the surface showed a flat shape, but serious irregular lines appear
X: after coating the surface showed an unflat shape, and serious irregular lines appear

TABLE 2

| | | | Examples | | | | | | | |
|---|---|---|---|---|---|---|---|---|---|---|
| Components | | | 1 | 2 | 3 | 4 | 5 | 6 | 7 | 8 |
| polysiloxane (A) | A-1 | A-1-1 | 100 | | | | | | 50 | 30 |
| (parts by weight) | | A-1-2 | | 100 | | | | | | |
| | | A-1-3 | | | 100 | | | | | |
| | | A-1-4 | | | | 100 | | | | |
| | | A-1-5 | | | | | 100 | | | |
| | | A-1-6 | | | | | | 70 | | |
| | A-2 | A-2-1 | | | | | | 30 | | 70 |
| | | A-2-2 | | | | | | | 40 | |
| acrylic acid resin (A′) | | | | | | | | | 10 | |
| triazine-based | B-1 | B-1-1 | 0.1 | | | | 1.8 | | | |
| compound (B) | | B-1-2 | | 0.3 | | 1.4 | | 2 | | |
| (parts by weight) | | B-1-3 | | | 1 | | | | 2.5 | 3 |
| | B-2 | B-2-1 | 0.2 | | | | 1 | | | 2 |
| | | B-2-2 | | | | | | | 1.5 | |

| | | | | | | | | | |
|---|---|---|---|---|---|---|---|---|---|
| solvent (C) | C-1 | 100 | | 300 | 400 | | 300 | 800 | |
| (parts by weight) | C-2 | | 200 | | | 500 | 400 | | 1000 |
| polydimethylsiloxane | D-1 | 0.01 | | | | | 0.8 | | |
| (D) comprising the | D-2 | | 0.1 | | 0.3 | 0.5 | | | |
| alkoxy group | D-3 | | | 0.2 | | 0.1 | | | 1 |
| (parts by weight) | | | | | | | | | |
| adhesion promoting | E-1 | 0.5 | | | 3 | | | 3 | |
| agent (E) | E-2 | | 1 | | | | | | 6 |
| (parts by weight) | E-3 | | | 2 | | | 4 | 2 | |
| Assays | adhesion | ⊚ | ⊚ | ⊚ | ⊚ | ◯ | ⊚ | ⊚ | ⊚ |
| | coating | ⊚ | ⊚ | ⊚ | ⊚ | ⊚ | ⊚ | ◯ | ⊚ |

TABLE 3

| | | | Comparative Examples | | | | |
|---|---|---|---|---|---|---|---|
| Components | | | 1 | 2 | 3 | 4 | 5 |
| polysiloxane (A) | A-1 | A-1-1 | | | 100 | | |
| (parts by weight) | | A-1-2 | | | | | 100 |
| | | A-1-3 | | | | | |
| | | A-1-4 | | | | | |
| | | A-1-5 | | | | | |
| | | A-1-6 | | | | | |
| | A-2 | A-2-1 | 100 | | | | |
| | | A-2-2 | | | | 100 | |
| acrylic acid resin (A′) | | | | 100 | | | |
| triazine-based | B-1 | B-1-1 | 2 | | | | |
| compound (B) | | B-1-2 | | 2 | | | |
| (parts by weight) | | B-1-3 | | | | | |
| | B-2 | B-2-1 | | | 2 | 2 | |
| | | B-2-2 | | | | | 3 |

| | | | | | | |
|---|---|---|---|---|---|---|
| solvent (C) | C-1 | 500 | 500 | 500 | | |
| (parts by weight) | C-2 | | | | 500 | 500 |
| polydimethylsiloxane (D) | D-1 | | | | | |
| comprising the alkoxy | D-2 | | | | | |
| group (parts by weight) | D-3 | | | | | |
| adhesion promoting | E-1 | | | | | |
| agent (E) | E-2 | | | | | |
| (parts by weight) | E-3 | | | | | |
| Assays | adhesion | X | X | X | X | X |
| | coating | X | X | ◯ | X | ◯ |

### in Tables 2 and 3:

B-1-1 2,4-di-p-tolyl-6-(2-hydroxy-4-propoxyphenyl)-1,3,5-triazine
B-1-2 2-[4-[(2-hydroxy-3-tridecyloxypropyl)oxy]-2-hydroxyphenyl]-4,6-bis(2,4-dimethylphenyl)-1,3,5-triazine
B-1-3 2,4-bis(2-hydroxy-4-butoxyphenyl)-6-(2,4-bis-butoxyphenyl)-1,3,5-triazine
B-2-1 2,4-diphenyl-6-(2-hydroxy-4-methoxyphenyl)-1,3,5-triazine
B-2-2 2,4-diphenyl-6-(2-hydroxy-4-hexyloxyphenyl)-1,3,5-triazine
C-1 4-hydroxy-4-methyl-2-pentanone
C-2 2-(2-ethoxyethoxyl)ethyl acetate
D-1 BYK-331
D-2 Guranoru 410
D-3 KF-351
E-1 vinyltrimethoxysilane
E-2 N-(2-aminoethyl)-3-aminopropyltrimethoxysilane
E-3 3-epoxypropoxypropyl trimethoxysilane

While embodiments of the present invention have been illustrated and described, various modifications and improvements can be made by persons skilled in the art. It is intended that the present invention is not limited to the particular forms as illustrated, and that all modifications not departing from the spirit and scope of the present invention are within the scope as defined in the following claims.

What is claimed is:

1. A curing resin composition comprising:
a polysiloxane (A);
a triazine-based compound (B); and
a solvent (C);
wherein:
the polysiloxane (A) comprises a polysiloxane (A-1) having an acid anhydride group or epoxy group, and the polysiloxane (A-1) is obtained by subjecting a reactant to hydrolysis and partial condensation, and the reactant includes at least one silane monomer having a structure of Formula (1):
Si(R¹)ₜ(OR²)₄₋ₜ Formula (1),
t represents an integer from 1 to 3; when t represents 2 or 3, a plurality of R¹ are independently the same or different; and when 4−t represents 2 or 3, a plurality of R² are independently the same or different;
at least one of R¹ represents a C₁-C₁₀ alkyl group substituted by an acid anhydride group, a C₁-C₁₀ alkyl group substituted by an epoxy group or an alkoxy group substituted by an epoxy group; and the remaining R¹ represent a hydrogen atom, a C₁-C₁₀ alkyl group, a C₂-C₁₀ alkenyl group or a C₆-C₁₅ aryl group; and
R² represents a hydrogen atom, a C₁-C₆ alkyl group, a C₁-C₆ acyl group or a C₆-C₁₅ aryl group; and
the triazine-based compound (B) comprises a triazine-based compound (B-1) represented by Formula (2); 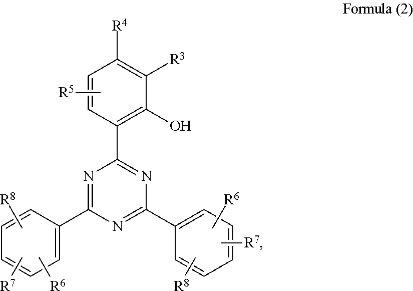
R³, R⁴, and R⁵ each independently represent a hydrogen atom, a halogen atom, an alkyl group or an alkoxy group; and
R⁶, R⁷, and R⁸ each independently represent a hydrogen atom, a halogen atom, an aryl group or an alkoxy group; and at least one of R⁶, R⁷, and R⁸ is not a hydrogen atom.

2. The curing resin composition according to claim 1, wherein based on 100 parts by weight of the used amount of the polysiloxane (A), the used amount of the polysiloxane (A-1) is from 30 to 100 parts by weight; the used amount of the triazine-based compound (B) is from 0.3 to 5 parts by weight; the used amount of the triazine-based compound (B-1) is from 0.1 to 3 parts by weight; and the used amount of the solvent (C) is from 100 to 1000 parts by weight.

3. The curing resin composition according to claim 1, further comprising a polydimethylsiloxane (D) comprising an alkoxy group represented by Formula (3); 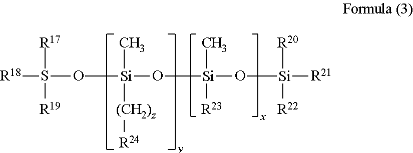
R¹⁷, R¹⁸, R¹⁹, R²⁰, R²¹, R²² and R²³ each independently represent a hydrogen atom, —CH₃, —C₂H₅, —C₃H₇, —OCH₃ or —OC₂H₅;
x, y and z independently represent an integer from 1 to 20;
R²⁴ represents a group represented by Formula (4) or Formula (5); 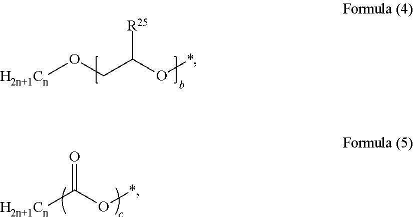
R²⁵ represents a hydrogen atom, a C₁-C₄ alkyl group, a cation polymerizable group or an ethylenically unsaturated group;
n represents an integer from 1 to 5; and
b and c represent an integer from 1 to 20 independently in Formula (4) and Formula (5).

4. The curing resin composition according to claim 3, wherein based on 100 parts by weight of the used amount of the polysiloxane (A), the used amount of the polydimethylsiloxane (D) represented by Formula (3) is from 0.01 to 1 parts by weight.

5. The curing resin composition according to claim 1, further comprising an adhesion promoting agent (E).

6. The curing resin composition according to claim 5, wherein based on 100 parts by weight of the used amount of the polysiloxane (A), the used amount of the adhesion promoting agent (E) is from 0.5 to 6 parts by weight.

7. A method for forming a thin film on a substrate comprising applying the curing resin composition according to claim 1 on the substrate.

8. A thin film on a substrate, which is manufactured by the method according to claim 7.

9. The thin film according to claim 8, wherein the thin film is a protective film in a liquid crystal display element.

10. An apparatus comprising the thin film according to claim 8.

11. An apparatus comprising the thin film according to claim 9.
